(19) United States
(12) Patent Application Publication
(10) Pub. No.: US 2007/0234372 A1
(43) Pub. Date: Oct. 4, 2007

(54) Management system for USB audio device cluster

(75) Inventor: Yun-Lung Wan, Taipei (TW)

Correspondence Address: BACON & THOMAS, PLLC, 625 SLATERS LANE, FOURTH FLOOR, ALEXANDRIA, VA, 22314, US

(73) Assignee: InfoAction Technology, Inc., Taipei (TW)

(21) Appl. No.: 11/730,267

(22) Filed: Mar. 30, 2007

(30) Foreign Application Priority Data
Mar. 30, 2006 (TW) 095111333

(51) Int. Cl. G06F 9/44

(52) U.S. Cl. 719/322

(57) ABSTRACT

The present invention provides a management system for USB (universal serial bus) audio device cluster, and various connection examples. The present invention includes several non-distinct USB audio devices on single system, each USB audio still seems as an independent device in the system and also has its corresponding vendor's driver. However, without present invention, users hardily distinguish the difference among each device by the vendor's driver, and it is very inconvenient and confusing to the users. In accordance with the present invention, users only need to verify pseudo drivers which are labeled with different names, so there won't be any problems for users to recognize distinct USB audio devices. The management system of the present invention using between the users and the USB audio devices cluster can support one-to-one mapping, and further support one-to-many, many-to-many, and many-to-one mappings under the management module.

### FIELD OF THE INVENTION

The present invention relates to a management system for USB (Universal Serial Bus) audio device cluster, and more particularly, relates to a management system for USB audio device cluster using in VoIP (Voice over Internet Protocol).

### BACKGROUND OF THE INVENTION

When a user purchases a personal computer, various devices could be chosen in order to meet one's needs, and there may be series products of keyboards, mice, monitors and speakers. In addition, vendors also provide many adapter cards inside the personal computer for consumers, for example series products of sound cards, video cards or network cards. Although, pluralities of candidates can be selected, only one of each kind could be installed into the personal computer. According to this manner, all device vendors follow this rule to design the corresponding drivers for their devices.

It is easy for a system to handle one audio device and one video device in one system, but it becomes a serious problem when the user tries to install two of the same devices in a single system. With the rapid growth of personal computer technologies, especially with faster computing power, the personal computer's function is thus more powerful than ever. It allows the user to execute many complicated programs on his personal computer, and these programs only can be executed on a mainframe which cost beyond user's affordable.

After the USB (universal serial bus) is introduced to increase more varieties to the personal computer's accessory, and the compatibility of the personal computer's accessories is raised as well. Typically, the USB can connect up to one hundred and twenty-eight USB devices, and these devices generally are with different functions, and no one is the same device with the others. But with the brand-new user behavior by using the VoIP (voice over internet protocol) technologies, there are some new needs must to be satisfied. Traditionally, one personal computer only can be equipped with one USB audio device, referring to FIG. 1, which is a system diagram illustrating a system 100 of one user with one USB audio device. In tradition, user 102A exists in an account layer 102, a corresponding USB audio device 106 is coupled to the account layer 102. User 102A utilizes the USB audio device 106 through vendor's driver 104A installed in a system layer 104 (i.e. operating system). Conventionally, the vendor's driver 104A is designed for driving single device. If the user 102A tries to install more than one similar device under the single system, it will be very difficult for the user 102A to distinguish each device. Moreover, every USB audio device has its relative vendor's driver; the same driver programs provided by the same vendor can not be managed by one single system. If users force to install the system, it will cause the system in damage or instable situations. In accordance with aforementioned description, it is obvious that traditional system fails to provide suitable support to fit needs of the user who wants to install multiple substantially same USB audio devices on single system. Besides, it is lack of practical solutions for multiple users to concurrently control the single USB audio device. With all above drawbacks of traditional system, what is desire is to have a system to manage USB audio device in various manners.

### SUMMARY OF THE INVENTION

The present invention fills the needs by providing a management system for USB (universal serial bus) audio device cluster. It should be appreciated that the present invention can be practical in various applications. The users may practice any one of them on demand to utilize multiple substantially the same USB audio devices in single system, and this will significantly simplify the complicate procedures for the same purposes in tradition.

Conventionally, users only install one USB audio device in one system due to humans' natural behaviors. Following the evolution of computer technologies, users change their behavior in accordance with newly software or system. In the past, users were familiar with text mode consoles. After the introducing of the windows technologies, users start to click and drag with just their mice. The changes are tremendous and radical; sometimes users can see a great vision in front of them, but the procedures or the entry barriers for this vision are too high to clamber. In recent years, VoIP (Voice over Internet Protocol) services became major trends, single user may use VoIP services provided by several service providers, for example, the users may have more than one Skype accounts, and even has an additional google talk account or the like. User has the demand for using all these services concurrently, however, it limited by the prior art system, and it seems not as easy as usual. Again, it is difficult for everyone to solve such problems except some computer technologist. In a manner for solving aforementioned issues, the present invention is disclosed.

When multiple users involve in the single system and only singular USB audio device is available, the utilities of the USB audio device are limited. Although some techniques are developed for this situation, like users may use the USB audio in turn, or labeling the users with different priority, they are still unable to let users control the single USB audio device concurrently. The present invention provides a management system including a management layer which is intermediate between an account layer and a system layer in a computer system. The management system includes a management module which has various functions, for example controlling virtual drivers' amount, and mapping virtual drivers to a physical driver (vendor's driver); and the management system acts as a connection between users and virtual drivers; and the management system comprises a plurality of virtual drivers which are referred to “pseudo driver”; all these pseudo drivers can be designed independently. It means that all pseudo drivers can be modified in order to reach users' special needs, and follow the API (application program interface) of system driver programming provided by relative system providers; this makes the pseudo driver can communicate with vendor's driver correctly and efficiently. Moreover, when the USB audio management system is successfully installed in the computer system, users can choose the pseudo driver from their applications' setup menus, in other words the users can select the pseudo drivers from the menus that are previously occupied by the vendor's drivers. Furthermore, at the moment the users' applications need to use the USB audio device, the management module will automatically map the pseudo driver to the corresponding vendor's driver of the USB audio device.

In opposition manner, multiple USB audio devices are provided with the same function or vendor in the computer system, one single user on this computer system wants to use them concurrently. The user may have several applications that must access the USB audio device at the same time, and the user only needs to assign different pseudo drivers to his applications, then the rest will be taken over by the management module. Description in detail, the management module will connect each pseudo driver with its corresponding vendor's driver, and all information will be saved in memory. After the management module receives a request from the user, the management module lookups the saved information in order to send a proper response to both the user and the corresponding vendor's driver. Therefore, the user can access the multiple USB audio devices concurrently with the disclosure of present invention.

Another purpose of the present invention is to handle the condition, when the single system includes both multiple users and USB audio devices. The processing ability of modern personal computer is far from our imagination, so it is a usual situation that one system has to accept various users accessing various devices concurrently. Traditionally, some devices can be easily shared, like hard disks, CPU, or printers; but it still fails to focus on USB audio devices shared. Several non-distinct USB audio devices are provided on the single system, but each USB audio is still regarded as an independent device in the system and also has its corresponding vendor's driver. However, without present invention, it is unlikely to allow the users to distinguish the difference among each device by the vendor's driver; therefore, it is very inconvenient and confusing to the users. In accordance with the present invention, the users only need to verify pseudo drivers which are labeled with different names, and no problems will be raised for the users to recognize distinct USB audio devices. The mapping policy introducing between the pseudo drivers and the vendor's drivers is not generally one-to-one. With the supports by the management module, it can map one-to-many, many-to-many, and many-to-one. The numbers of the pseudo drivers can be equal to or more than the amounts of the vendor's drivers. The aforementioned USB audio device includes a VoIP gateway, and the VoIP gateway can be a software gateway or a hardware gateway; the software gateway is designed in a manner of software for installing on a personal computer; the hardware gateway is designed in an independent manner and does not be supported by other hardware device.

Thus, the present invention discloses a management system for USB audio device cluster comprising an account layer including one or more user applications; a management layer including one or more pseudo drivers and a management module. The system layer includes one or more vendor's drivers, and wherein the management layer is between the system layer and the account layer. The system layer further includes a USB channel for coupling one or more USB audio devices. The user application comprises a VoIP application and the USB audio device comprises a VoIP gateway. The vendor's drivers include a one-to-one mapping relation with the USB audio devices. Further, the management layer does not fully cover said system layer. The VoIP gateway includes a software gateway or a hardware gateway.

A management system for USB audio device cluster in a VoIP environment is disclosed. The present invention comprises a management system including an account layer, a management layer and a system layer, wherein the management layer is between the system layer and the account layer. One or more VoIP gateways are coupled to the system layer by a USB channel, and one or more PBXs are coupled to the VoIP gateways by RJ-11s.

The account layer includes one or more user applications and the management layer includes one or more pseudo drivers and a management module. In the case, the management layer does not fully cover the system layer. The VoIP gateway includes a software gateway or a hardware gateway, the PBX comprises an analog PBX, a digital PBX or an IP-PBX. The user application comprises a VoIP application and the vendor's drivers include a one-to-one mapping relation with said VoIP gateways.

### BRIEF DESCRIPTION OF THE DRAWINGS

The present invention will be readily understood by the following detailed description in conjunction with the accompanying drawings.

FIG. 1 is a system diagram of prior art.

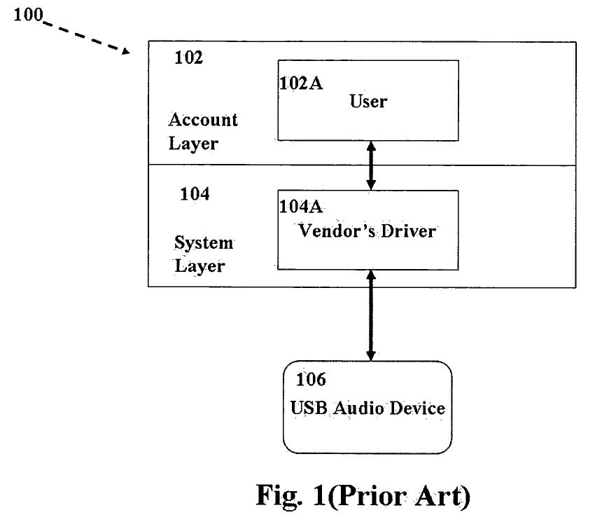

FIG. 2 is a system diagram illustrating multiple users using single USB audio device according to the present invention.

FIG. 3 is a system diagram illustrating single user using multiple USB audio devices according to the present invention.

FIG. 4 is a system diagram illustrating multiple users using multiple USB audio devices according to the present invention.

FIG. 5 is a system diagram of VoIP exemplary connection according to the present invention.

### DETAILED DESCRIPTION OF THE PREFERRED EMBODIMENT

The present invention is described with preferred embodiments and accompanying drawings. It should be appreciated that all the embodiments are merely used for illustration. Although the present invention has been described in term of a preferred embodiment, the invention is not limited to this embodiment. It will be understood, however, to one skilled in the art, that the present invention may be practiced without some or all of these specific details. In other instances, well known process operations have not been described in detail in order not to unnecessary obscure the present invention.

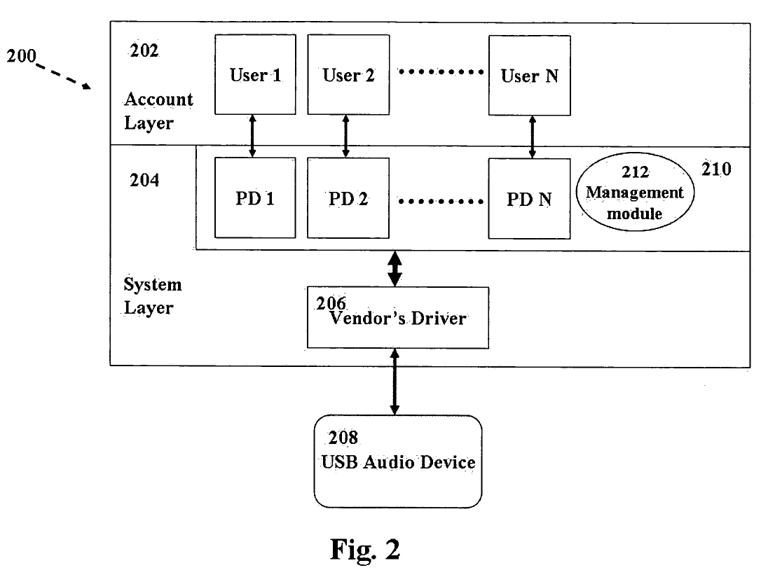

Referring to FIG. 2, which is a system diagram, recites multiple users using single USB audio device in single system 200. There are three different layers from top to bottom in the system 200, which includes an account layer 202, a management layer 210 and a system layer 204. Besides, there is a USB audio device 208 that is coupled to the system 200 by USB channel, taking a VoIP gateway as example, the VoSKY 6000 of the Infoaction technology, Inc. The system 200 includes a vendor's driver 206, which is located at the system layer 202, to control or signal the USB audio device 208. Moreover, accompanying with FIG. 2, the system layer 204 is not fully covered by the management layer 210, and this means that the account layer 202 still can directly access the vendor's driver 206 without any other pseudo drivers. Multiple user accounts are included in the account layer 202, and all these accounts which are labeled from User 1 to User N sequentially, stand for distinct applications. Aforementioned applications can be some VoIP applications or other applications that are compatible to the USB audio device 208. A management module 212 in the management layer 210 is used for controlling and managing all pseudo drivers that will be mentioned latter. The pseudo drivers which are named from PD 1 to PD N in FIG. 2, are designed for connection between the applications and the vendor's driver 206. All pseudo drivers are programmed under the driver's specification of the corresponding OS (operating system), under the management of the management module 212 and programmed with the driver's API (application program interface) provided by the system maker.

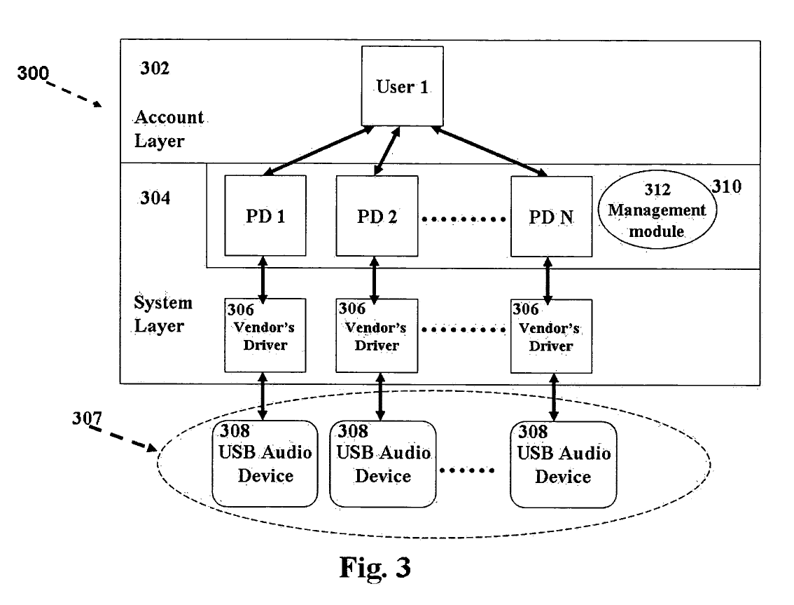

FIG. 3 is a system diagram illustrating single user using multiple USB audio devices in single system 300. Three different layers are constructed from top to bottom in the system 300, which includes an account layer 302, a management layer 310 and a system layer 304. A USB audio device cluster 307 having multiple USB audio devices 308 is coupled to the system 300 by various USB channels. The USB audio device cluster stands for a set of multiple USB audio devices, or merely a single USB audio device that is connected to the system 300 by multiple USB channels, taking a VoIP gateway as example, the VoSKY 9000 of the Infoaction technology, Inc. The system 300 employs vendor's drivers 306, which are located at the system layer 302, to control or signal the USB audio devices 308. Moreover, accompanying with FIG. 3, the system layer 304 is not fully covered by the management layer 310, namely, the account layer 302 can directly access the vendor's drivers 306 without any other pseudo drivers. A user account labeled as User 1 is in the account layer 302 stands for some unspecific application. Aforementioned application can be some VoIP applications or other applications that need to be supported by the USB audio devices 308. A management module 312 locates at the management layer 310 is used for controlling and managing all pseudo drivers. Similarly, the pseudo drivers (PD 1 to PD N) are designed for connecting the applications and the vendor's drivers 306. All pseudo drivers are programmed under the driver's specification of the corresponding OS (operating system), under the management of the management module 312 and programmed with the driver's API (application program interface) that is provided by the system maker.

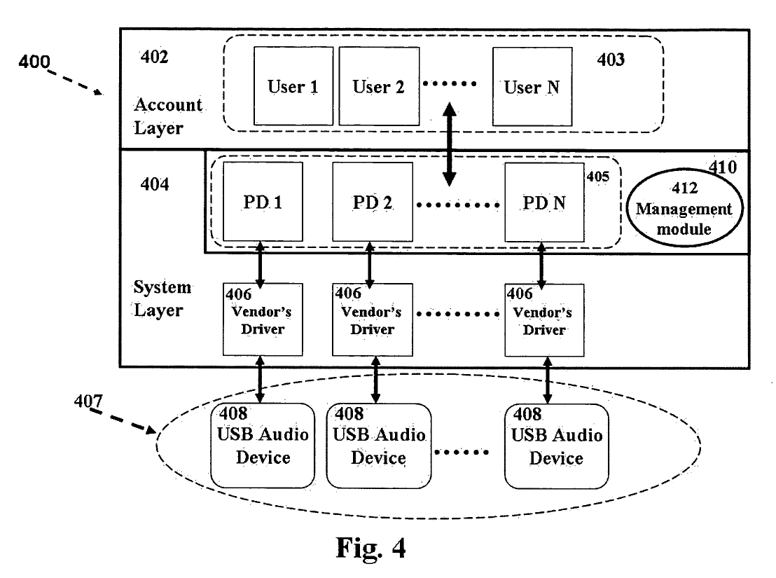

As shown in FIG. 4, it recites multiple users using multiple USB audio devices in single system 400. The system 400 is similar to the embodiment illustrated in FIG. 3 except the account layer 402. The system also includes three layers consisting of an account layer 402, a management layer 410 and a system layer 404. Similarly, the USB audio device cluster 407 also includes multiple USB audio devices 408 coupled to the system 400 by various USB channels. The description of other similar parts are omitted to avoid the redundancy. However, it should be noted that multiple user accounts are regarded as an account set 403 in the account layer 402. The accounts labeled from User 1 to User N sequentially stand for distinct applications. A pseudo driver set 405 comprises a plurality of pseudo drivers PD 1 to PD N are designed for connecting between the applications and the vendor's drivers 406.

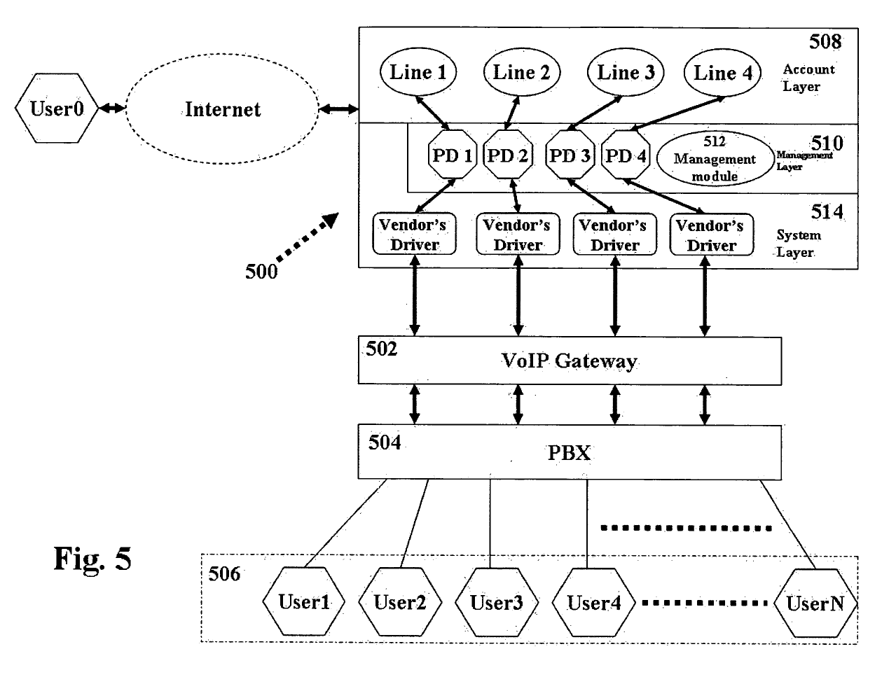

Referring to FIG. 5, it illustrates a system diagram that excites an exemplary system connection of the present invention. In this preferred embodiment, the present invention includes a management system 500 coupled to the internet and a VoIP gateway 502, respectively. A PBX (private branch exchange) 504 is coupled to the VoIP gateway 502 that is coupled to a set of users' extensions 506. The preferred embodiment mainly focuses on the VoIP network establishment of the enterprise, and assists the enterprise easily to manage or secure their own VoIP network. In accordance with preferred embodiment, wherein the management system 500 further comprises three different layers from top to bottom, including an account layer 508, a management layer 510 and a system layer 514. Besides, the VoIP gateway 502 is coupled to the management system 500 by a plurality of, for example four, distinct USB channels. A User0 is coupled to the internet as shown in FIG. 5, the User0 stands for a caller or a callee in other VoIP network. In the embodiment, the VoIP gateway 502 with 4-ports (any number could be used) of USB channel after the user successfully installs the vendor's driver on the system layer 514. Although the VoIP gateway 502 has 4-ports, the management system 500 will be capable to recognize four USB channels. Therefore, the user will find out the four non-distinct vendor's drivers (i.e. user can not tell which driver is USB port one, and which driver is USB port two). Those will cause the identification difficulties in distinguishing four distinct lines (i.e. four USB ports), and the applications can not allocate correct devices. The PBX 504 can be traditional (analog) PBX, digital PBX or IP-PBX, and the PBX 504 is coupled to the VoIP gateway 502 by four RJ-11s. Furthermore, the present invention will not be limited by the numbers of the user's extensions coupled to the PBX 504, and all extensions are regarded as the set 506 in the FIG. 5. The types of the user's extension are flexible but should be compatible with the supporting types of the PBX 504. Moreover, there are four lines which are labeled as Line 1, Line 2, Line 3 and Line 4 in the FIG. 5, and each line stands for one usable VoIP account or number, for example, a google talk, a Skype or the like. In this preferred embodiment, the management system 500 provides four lines for VoIP services. Each line has its corresponding pseudo driver (labeled as PD 1, PD 2, PD 3 and PD 4 in the FIG. 5) that is installed in the management layer 510 and all pseudo drivers are managed by the management module 512. According to the benefits of the pseudo drivers, users can choose the right devices for their applications with almost no efforts. Besides, the physical connection between each device can be modified efficiently and correctly as well.

Other embodiments of the invention will be apparent to those skilled in the art from consideration of the specification and practice of the invention. The word “comprising” and forms of the word “comprising” as used in the description and in the claims are not meant to exclude variants or additions to the invention. Furthermore, certain terminology has been used for the purposes of descriptive clarity, and not to limit the present invention. The embodiments and preferred features described above should be considered exemplary, with the invention being defined by the appended claims.

We claim:

1. A management system for USB audio device cluster, comprising:
an account layer including one or more user applications;
a management layer including one or more pseudo drivers and a management module;
a system layer including one or more vendor's drivers, wherein said management layer is between said system layer and said account layer; and wherein said system layer includes a USB channel for coupling one or more USB audio devices.

2. The management system of claim 1, wherein said user application comprises a VoIP application.

3. The management system of claim 1, wherein said USB audio device comprises a VoIP gateway.

4. The management system of claim 1, wherein said vendor's driver includes a one-to-one mapping relation with said USB audio devices.

5. The management system of claim 1, wherein said management layer does not fully cover said system layer.

6. The management system of claim 3, wherein said VoIP gateway includes a software gateway or a hardware gateway.

7. A management system for USB audio device cluster in a VoIP environment, comprising:
a management system including an account layer, a management layer and a system layer, wherein said management layer is between said system layer and said account layer;
one or more VoIP gateways coupled to said system layer by a USB channel;
one or more PBXs coupled to said VoIP gateways by RJ-11s.

8. The management system of claim 7, wherein said account layer includes one or more user applications.

9. The management system of claim 7, wherein said management layer includes one or more pseudo drivers and a management module.

10. The management system of claim 7, wherein said system layer includes one or more vendor's drivers.

11. The management system of claim 7, wherein said management layer is not fully covering said system layer.

12. The management system of claim 7, wherein said VoIP gateway includes a software gateway or a hardware gateway.

13. The management system of claim 7, wherein said PBX comprises an analog PBX, a digital PBX or an IP-PBX.

14. The management system of claim 8, wherein said user application comprises a VoIP application.

15. The management system of claim 10, wherein said vendor's drivers includes a one-to-one mapping relation with said VoIP gateways.
